(19) United States
(12) Patent Application Publication
(10) Pub. No.: US 2014/0306520 A1
(43) Pub. Date: Oct. 16, 2014

(54) POWER SUPPLY CONTROL DEVICE

(71) Applicant: Panasonic Corporation, Osaka (JP)

(72) Inventors: Hironobu Oe, Osaka (JP); Shinichi Nakamura, Osaka (JP); Tatsuya Mukai, Mie (JP); Noboru Inagaki, Mie (JP)

(73) Assignee: PANASONIC CORPORATION, Osaka (JP)

(21) Appl. No.: 14/357,033

(22) PCT Filed: Nov. 21, 2012
(86) PCT No.: PCT/IB2012/002410

§ 371 Date: May 8, 2014

(30) Foreign Application Priority Data
Nov. 22, 2011 (JP) 2011-254539

(51) Int. Cl. B60R 16/03; B60L 11/18

(52) U.S. Cl. CPC B60R 16/03; B60L 11/1816
USPC 307/9.1

(57) ABSTRACT

The power supply control device includes a body block having a power supply control unit for controlling power supply to an electric motor vehicle, a first cable, connected to the body block, for receiving electric power from a power source, and a second cable, connected to the body block, for feeding the electric power to the electric motor vehicle. One of the body block, and the first cable or the second cable includes an attaching lock part having a cylindrical tubular portion. The other of the body block, and the first cable or the second cable includes an attaching part having an portion to be inserted into the cylindrical tubular portion. The attaching lock part includes an elastic locking piece having a claw with a variable protruding. The claw is engaged with an engaging portion provided on an outer surface of the inserting portion to lock the attaching part.

### FIELD OF THE INVENTION

The present invention relates to a power supply control device.

### BACKGROUND OF THE INVENTION

Conventionally, there is used a power supply control device that electrically connects a power source to a secondary battery for controlling an electric power supplied to the secondary battery. The power source includes, e.g., a receptacle attached to an outer wall of a house. The secondary battery is mounted in vehicles (hereinafter, referred to as “electric motor vehicles”) such as a hybrid electric vehicle (HEV), and a plug-in hybrid electric vehicle (PHEV).

For such a power supply control device, there has been known a kind of power supply control device including: a body block for controlling the charging of the electric motor vehicle; a power side cable, electrically connected to the body block, for receiving electric power from the power source; and a vehicle side cable, electrically connected to the body block, for feeding the electric power to the electric motor vehicle (see, e.g., Japanese Unexamined Patent Application Publication No. 2011-176920).

As shown in FIG. 8, the power supply control device disclosed in the above cited reference includes: a holder 103 included in the power side cable or the vehicle side cable; and a casing 106 configured to cover an entire housing 102 of a body block 101. The casing 106 is constituted by two half-segment bodies 106a, 106b coupled to each other to accommodate the housing 102 therein. The half-segment bodies 106a, 106b have case bodies 163a, 163b, and two semi-cylindrical parts 161a, 161b for covering a joint part 121 (cylindrical fitting part 121a) protruding from the housing 102.

When the holder 103 is attached to the joint part 121, an engaging piece 135 is gradually and elastically deformed along an engaging protrusion 121e as the fitting part 121a is fitted into a connecting recess (not shown) of the holder 103. When the engaging protrusion 121e reaches an engaging hole 135a, the engaging piece 135 is restored by its elasticity and the engaging protrusion 121e is engaged with the engaging hole 135a. Accordingly, the holder 103 is locked to the joint part 121.

While fixing the housing 102, the casing 106 covers the engaging hole 135a and the engaging protrusion 121e engaged with the engaging hole 135a. The casing 106 prevents elastic deformation of the engaging piece 135 which may cause disconnection of the engaging protrusion 121e from the engaging hole 135a. Thus, the holder 103 is prevented from being accidentally detached from the housing 102.

The power supply control device disclosed in the above cited reference can improve its maintainability when the cable is replaced.

Meanwhile, plugs of the power side cables connected to the power source may have different shapes depending on countries or regions. If the power supply control devices are differently manufactured depending on the shapes of the plugs, various kinds of power supply control devices will be required. Similarly, plugs of the vehicle side cables connected to the electric motor vehicle may have different shapes depending on the kinds of vehicles or the like. If the power supply control devices are differently manufactured depending on the kinds of vehicles, various kinds of power supply control devices will be required. Accordingly, in the power supply control device, it is preferable that the power side cable and/or the vehicle side cable can be replaced. Further, when the cable is broken, it is desired that only the cable is replaced separately from the body block of the power supply control device.

In the power supply control device disclosed in the above cited reference, the cable is attached to and detached from the body block 101 through the engagement and disengagement between the engaging protrusion 121e and the engaging hole 135a of the engaging piece 135. The cable and the body block 101 are fixed by the casing 106 to improve the waterproof property. However, when the cable is disconnected from the body block 101 to be replaced, the casing 106 is required to be detached from the housing 102.

In the power supply control device for connecting the electric motor vehicle to the power source, it is still required to make the attachment and detachment of the cable to and from the body block easier.

### SUMMARY OF THE INVENTION

In view of the above, an object of the present invention is to provide a power supply control device capable of making the attachment and detachment of a cable to and from a body block easier.

The power supply control device in accordance with an aspect of the present invention includes: a body block including a power supply control unit for controlling power supply to an electric motor vehicle; a first cable, connected to the body block, for receiving electric power from a power source; and a second cable, connected to the body block, for feeding the electric power to the electric motor vehicle. One of the body block, and the first cable or the second cable includes an attaching lock part having a tubular portion, and the other of the body block, and the first cable or the second cable includes an attaching part having an inserting portion to be inserted into the tubular portion. The attaching lock part includes an elastic locking piece having a claw whose protruding amount from an inner wall surface of the tubular portion is variable, and the claw is engaged with an engaging portion provided on an outer surface of the inserting portion to lock the attaching part.

In the power supply control device, the attaching lock part may include an alignment portion, provided on the tubular portion, for aligning a connection terminal of the body block with a connection terminal of the first or second cable to be electrically connected to each other when the inserting portion is inserted into the tubular portion.

In the power supply control device, the tubular portion may include a waterproof seal provided on the inner wall surface thereof. The waterproof seal is in contact with the outer surface of the inserting part and prevents water from infiltrating between the tubular portion and the inserting portion.

In the power supply control device, the attaching lock part may further include a deflection restricting part which is in contact with the elastic locking piece to restrict the elastic locking piece from being deflected in a direction away from the outer wall surface and keep the elastic locking piece in a state that the claw is engaged with the engaging portion. The claw of the elastic locking piece disposed on the outer wall surface of the tubular portion may be inserted into a hole to protrude into the tubular portion beyond the inner wall surface thereof, the hole extending through from the outer wall surface to the inner wall surface of the tubular portion. The deflection restricting part may be slidable between a locked position where the deflection restricting part is in contact with the elastic locking piece to restrict the elastic locking piece from being deflected away from the outer wall surface and keep the elastic locking piece in the state that the claw is engaged with the engaging portion and an unlocked position where the elastic locking piece is allowed to be deflected so that the protruding amount of the claw from the inner wall surface into the tubular portion is decreased to release the engagement of the claw with the engaging portion.

In the power supply control device, the waterproof seal may be provided closer to the connection terminal of the body block than the hole in an inserting direction of the inserting portion.

The power supply control device in accordance with the present invention can attach and detach the cable to and from the body block easily.

### BRIEF DESCRIPTION OF THE DRAWINGS

The objects and features of the present invention will become apparent from the following description of embodiments, given in conjunction with the accompanying drawings, in which:

FIG. 1 is a cross-sectional explanatory view showing a main part of a body block of a power supply control device in accordance with the present embodiment;

FIG. 2 is an exploded perspective view showing the main part of the power supply control device;

FIG. 3 is a plan view showing the main part of the power supply control device;

FIG. 4 is an external view of the power supply control device;

FIG. 5 is a block diagram showing a schematic configuration of the power supply control device;

FIGS. 6A to 6D are explanatory views showing the states where an attaching portion is attached to an attaching lock part in accordance with the present embodiment;

FIGS. 7A to 7C are explanatory views showing the states where the attaching portion is detached to the attaching lock part; and

FIG. 8 is an exploded perspective view showing a main part of a conventional power supply control device.

### DETAILED DESCRIPTION OF THE EMBODIMENT

5

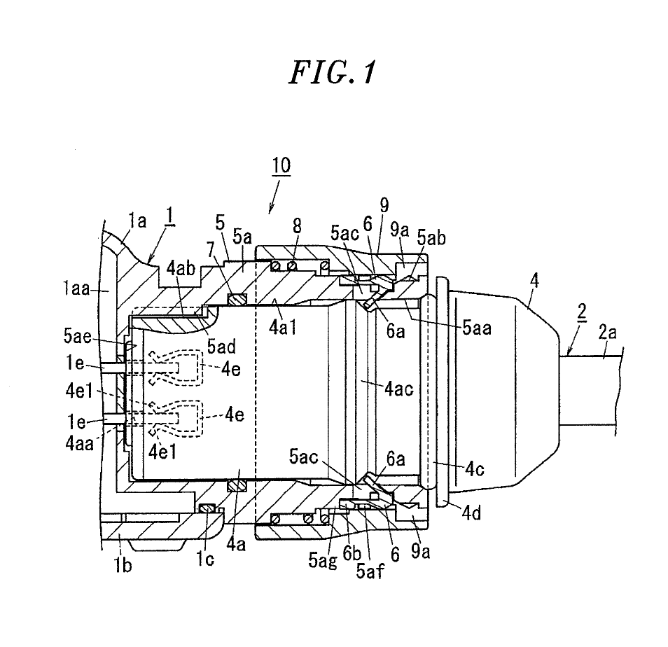

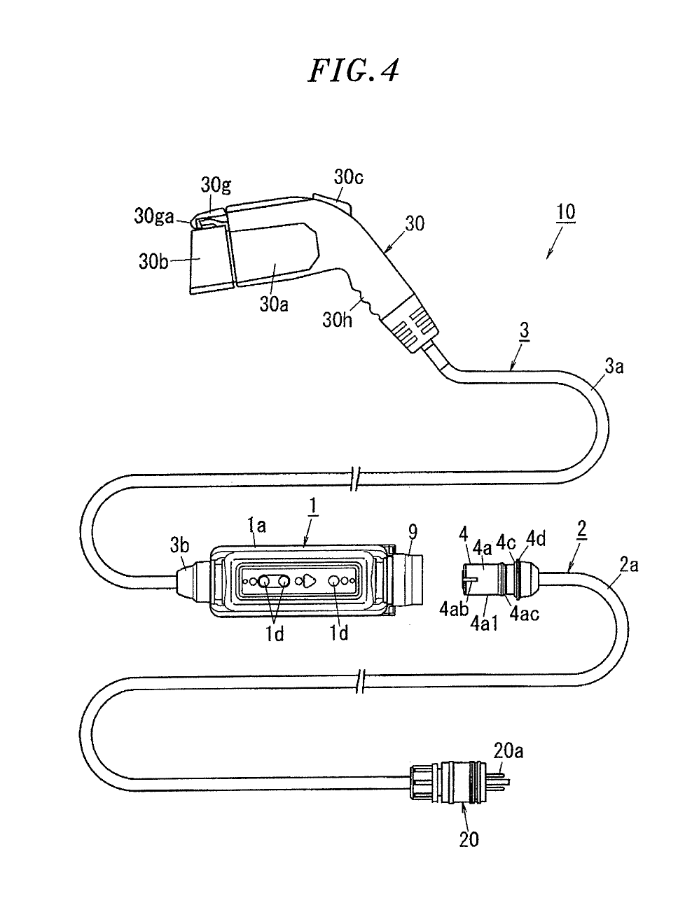

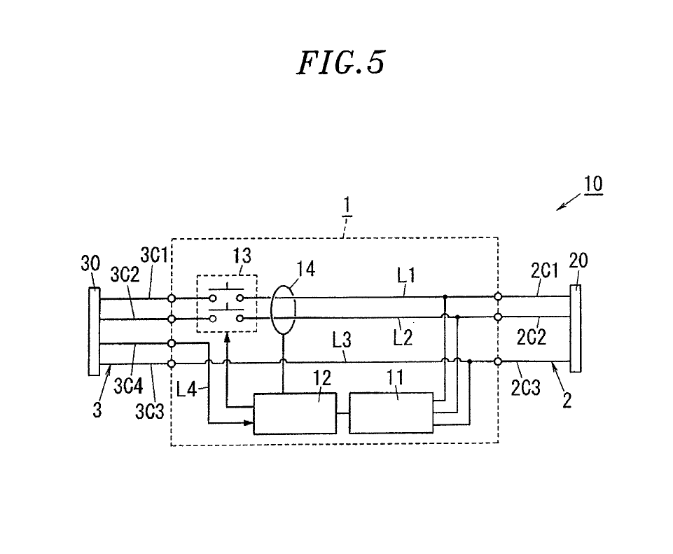

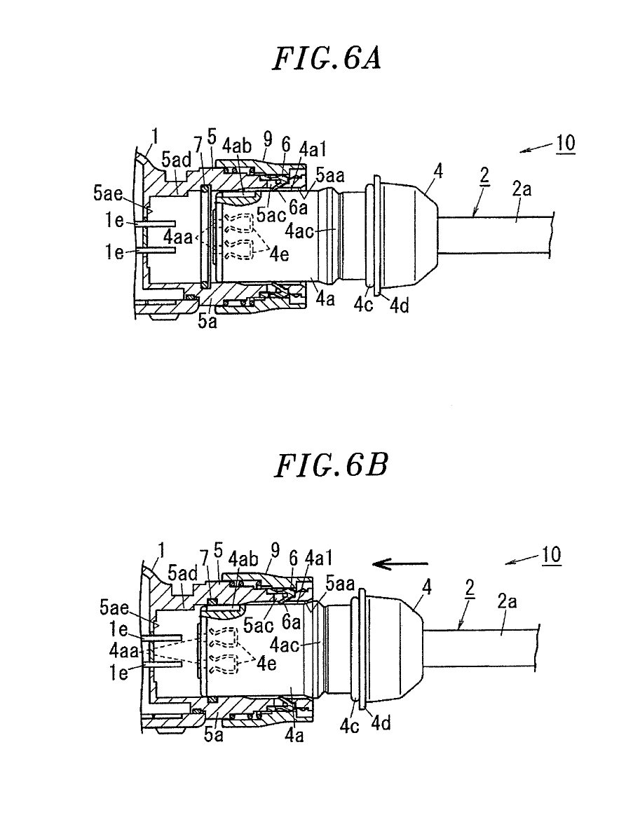

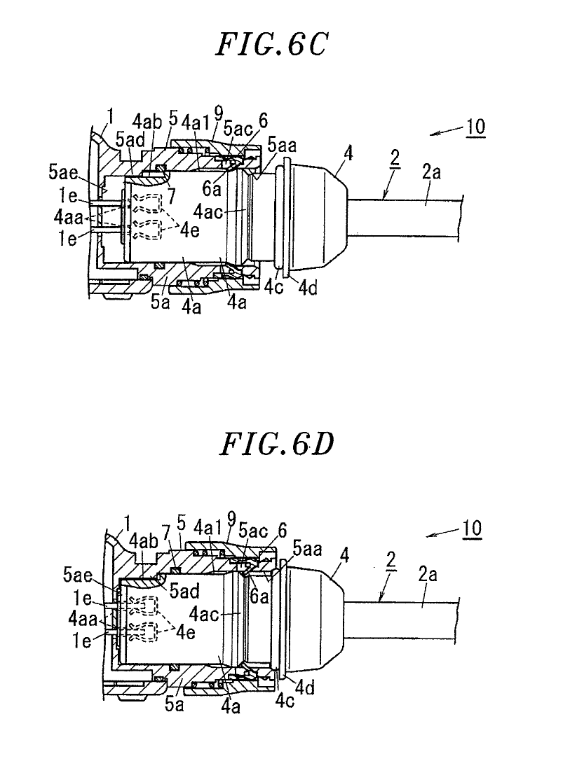

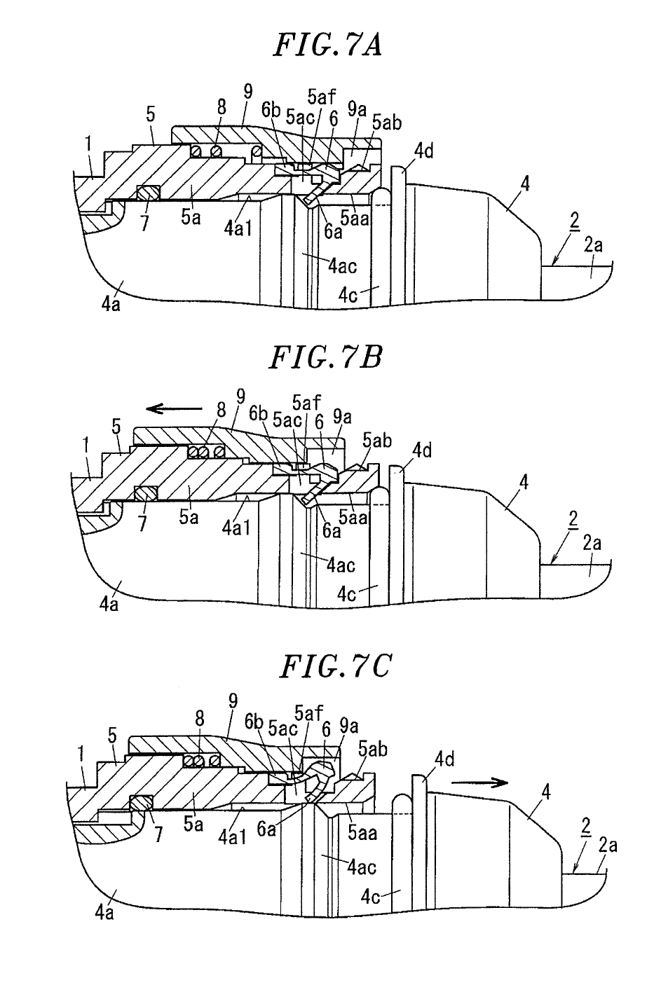

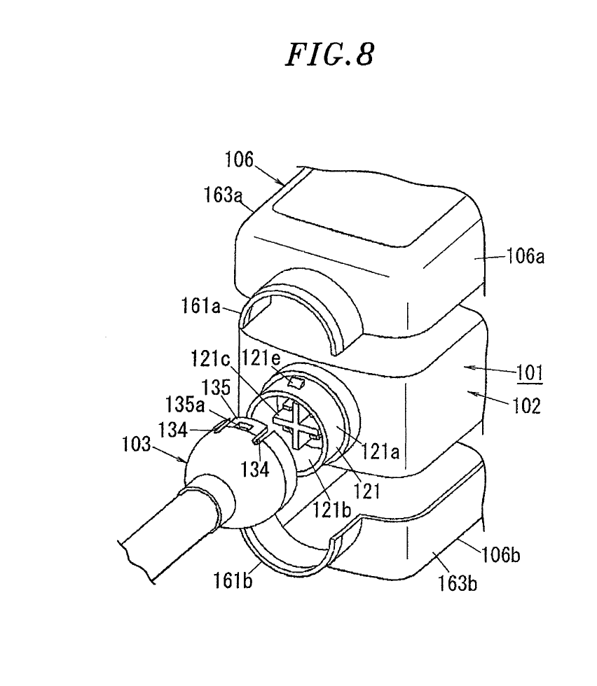

Hereinafter, a power supply control device 10 of an embodiment of the present invention will be described with reference to FIGS. 1 to 7C. A main part of the power supply control device 10 will be described using FIGS. 1 to 3, and an entire structure will be described using FIGS. 4 and 5. Further, an operation of the main part of the power supply control device 10 will be described using FIGS. 6A to 7C.

First of all, the entire structure of the power supply control device 10 in accordance with the present embodiment will be described. As shown in FIG. 4, the power supply control device 10 of the present embodiment includes a body block 1 having a power supply control unit for controlling power supply to an electric motor vehicle (not shown). Further, the power supply control device 10 includes a first cable 2, connected to the body block 1, for receiving electric power from a power source (not shown); and a second cable 3, connected to the body block 1, for feeding the electric power to the electric motor vehicle.

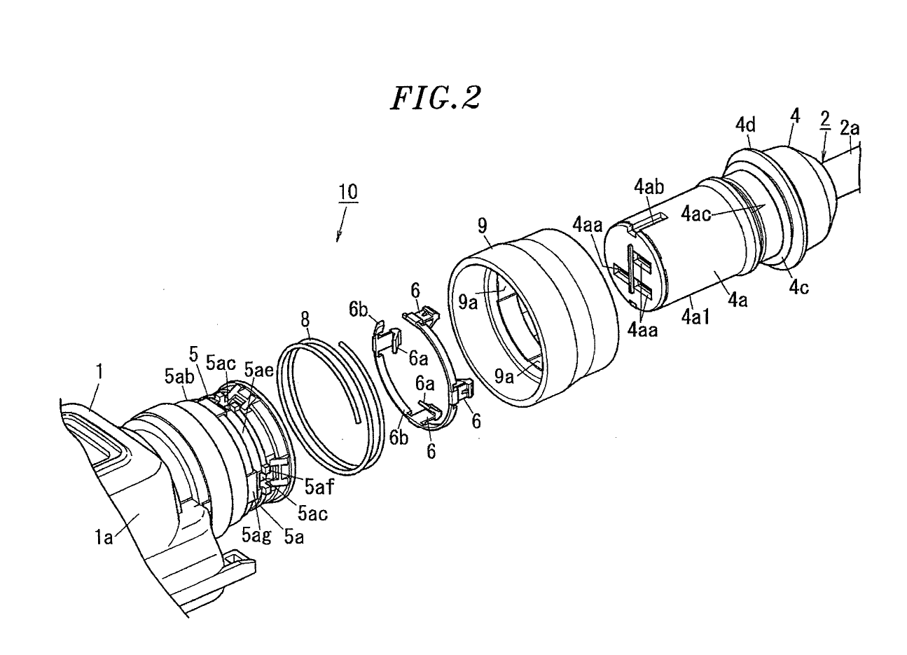

As shown in FIGS. 1 to 2, the body block 1 of the power supply control device 10 in the present embodiment includes an attaching lock part 5 having a cylindrical tubular portion 5a. Further, the first cable 2 of the power supply control device 10 includes an attaching part 4 having an inserting portion 4a to be inserted into the cylindrical tubular portion 5a.

The attaching lock part 5 in the present embodiment includes one or more elastic locking pieces 6 each having a claw 6a that protrudes into the cylindrical tubular portion 5a beyond an inner wall surface 5aa thereof, the protruding amount of the claws 6a from the inner wall surface 5aa being variable. The claws 6a are engaged with an engaging portion 4acprovided on an outer surface 4a1 of the inserting portion 4a to lock the attaching part 4 to the attaching lock part 5.

Accordingly, in the power supply control device 10 of the present embodiment, the first cable 2 can easily be attached to and detached from the body block 1. Note that, in the power supply control device 10 of the present embodiment, the first cable 2 may be provided with the attaching lock part 5 having the cylindrical tubular portion 5a, and the body block 1 may be provided with the attaching part 4 having the inserting portion 4a to be inserted into the cylindrical tubular portion 5a.

In the power supply control device 10 of the present embodiment, there is described the case where the second cable 3 is previously connected and fixed to the body block 1. Similarly to the first cable 2, one of the body block 1 and the second cable 3 may be provided with the attaching lock part 5 having the cylindrical tubular portion 5a, and the other may be provided with the attaching part 4 having the inserting portion 4a to be inserted into the cylindrical tubular portion 5a, thus making it easier to attach and detach the second cable 3 to and from the body block 1 of the power supply control device 10.

Note that the electric motor vehicle, as a vehicle driven by an electric motor, may include an electric vehicle (EV), an electric motorcycle, and the like which are equipped with only an electric motor as a driving source. Further, the electric motor vehicle may include a hybrid electric vehicle (HEV), a plug-in hybrid vehicle (PHEV), and the like which are equipped with a gasoline engine and an electric motor as the driving source.

Hereinafter, the configuration of the power supply control device 10 in accordance with the present embodiment will be described in detail.

The body block 1, as shown in FIG. 4, is connected to the second cable 3 including a vehicle side plug 30 serving as a charging gun. The vehicle side plug 30 is adapted to be connected to a charging port (not shown) provided in the electric motor vehicle. The power supply control device 10 can feed electric power to a secondary battery mounted in the electric motor vehicle via the first cable 2 receiving the electric power from the power source, the body block 1 connected to the first cable 2, and the second cable 3 connected to the body block 1. The vehicle side plug 30 includes a substantially L-shaped plug body 30a. The plug body 30a has a protruding cylindrical connection part 30b to be electrically and mechanically connected to the electric motor vehicle. In the vehicle side plug 30, a cable part 3a of the second cable 3 is extended from the opposite side of the plug body 30a to the connection part 30b. The vehicle side plug 30 feeds the electric power to the charging port through a conductive part (not shown) included in the connection part 30b. The plug body 30a of the vehicle side plug 30 has a grip portion 30h for making it easier to grip the vehicle side plug 30 by a user's hand.

Furthermore, the vehicle side plug 30 includes a latch part 30g made of a metal. The latch part 30g has a locking claw 30ga. The locking claw 30ga is hooked on a locking part provided at the charging port of the electric motor vehicle to prevent the vehicle side plug 30 from being disconnected from the charging port of the electric motor vehicle while charging the secondary battery mounted in the electric motor vehicle.

In the plug body 30a of the vehicle side plug 30, a release button 30c of a push-button type is provided on a back surface of the plug body 30a from which the cable part 3a is extended. The latch part 30g having the locking claw 30ga can be moved by pushing the release button 30c.

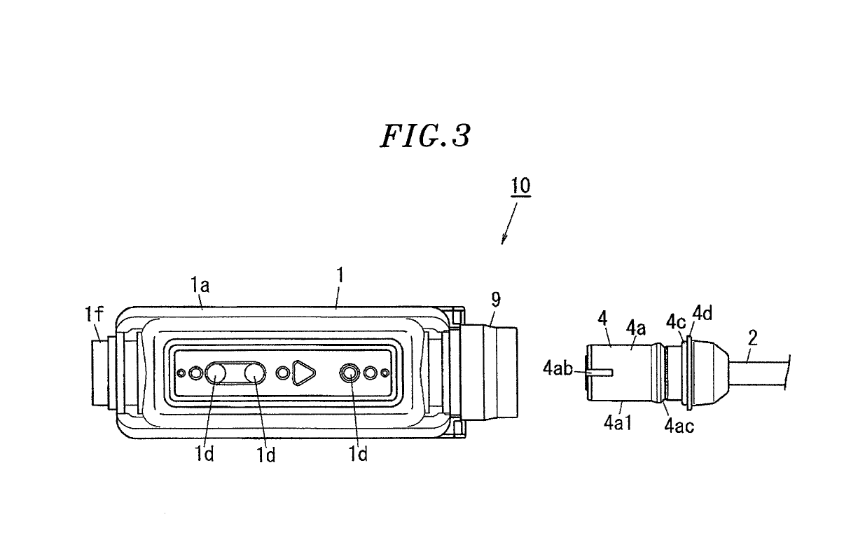

The second cable 3 is attached to the body block 1 having a Charging Circuit Interrupt Device (CCID) serving as the power supply control unit on its power source side. The body block 1 can determine whether or not the second cable 3 is connected to the electric motor vehicle, perform leakage detection, and electrically disconnect the electric motor vehicle from the power source when detecting abnormality. Further, the power supply control device 10 of the present embodiment includes a tubular portion if on the side of a body 1a of the body block 1 opposite to the side where the first cable 2 is connected (see FIG. 3). In the power supply control device 10, the cable part 3a is extended from the tubular portion if provided on the body 1a of the body block 1 via a cord bush (not shown). Further, in the body block 1, the cord bush is protected by being covered with a cap 3b (see FIG. 4).

A power supply circuit 11, a control circuit 12, a relay 13, and the like, which are shown in FIG. 5, are accommodated in the body 1a of the body block 1. The power supply control device 10 includes conductive paths between a power source, such as a commercial AC power source, and the electric motor vehicle. The conductive paths include a power electrode line L1 serving as a power electrode conductive path; a ground electrode line L2 serving as a ground electrode conductive path; and a ground line L3 serving as an earth line. The conductive paths on the side of the second cable 3 further includes a signal line L4 serving as a signal path to transmit electric signals from the electric motor vehicle to the body block 1.

In the power supply control device 10, the body block 1 includes the relay 13 connected to the power electrode line L1 and the ground electrode line L2 for controlling ON/OFF of the power supply from the power source to the electric motor vehicle. Further, the body block 1 includes the control circuit 12 for controlling ON/OFF of the relay 13. Furthermore, the body block 1 includes the power supply circuit 11 connected to the power electrode line L1, the ground electrode line L2, and the ground line L3 on the power source side of the relay 13. The power supply circuit 11 serves to generate electric power for the control circuit 12. The body block 1 further includes a zero phase current transformer 14 on the power source side of the relay 13. The power electrode line L1 and the ground electrode line L2 pass through the zero phase current transformer 14.

In the body block 1, the control circuit 12 detects an electric leakage based on an induction current induced in the zero-phase current transformer 14. When detecting an electric leakage, the control circuit 12 controls the relay 13 to stop feeding the electric power to the electric motor vehicle. Specifically, in the body block 1 of the power supply control device 10, the power supply control unit includes the power supply circuit 11, the control circuit 12, the relay 13, the zero-phase current transformer 14, and the like. The body block 1 of the power supply control device 10 controls the relay 13 to open and disconnect the conductive path between an electric wire 2C1 serving as the power electrode line of the first cable 2 and an electric wire 3C1 serving as the power electrode line of the second cable 3. Further, the body block 1 controls the relay 13 to open and disconnect the conductive path between an electric wire 2C2 serving as the ground electrode line of the first cable 2 and an electric wire 3C2 serving as the ground electrode line of the second cable 3.

The power supply control device 10 opens the relay 13 to shut off the electric power from the body block 1 to the electric motor vehicle, and closes the relay 13 to feed the electric power from the body block 1 to the electric motor vehicle. The control circuit 12 transmits a pilot signal to an Electronic Control Unit (ECU) mounted in the electric motor vehicle and notifies the ECU of the rated current of the body block 1. Thus, the ECU charges the secondary battery of the electric motor vehicle with a charging current based on the rated current of the body block 1. Further, the control circuit 12 has a function of forcibly opening the relay 13 to shut off the power supply when detecting abnormality such as an electric leakage.

As shown in FIG. 4, three light indicators 1d are arranged on the front surface of the body 1a in the longitudinal direction of the body block 1 (the left-right direction in FIG. 4). The light indicators 1d are constituted by, e.g., light-emitting diodes having different luminous colors from one another. The lighting states of the light indicators 1d indicate a state of charge of the secondary battery in the electric motor vehicle.

Secondly, as shown in FIG. 1, the body block 1 of the power supply control device 10 includes the body 1a for accommodating the circuit components of the power supply control unit; and a cover 1b for covering an accommodation recess 1aa of the body 1a. Further, the body block 1 has a cylindrical tubular body 5a with a closed bottom which protrudes from one longitudinal end of the body 1a. The tubular body 5a is integrally formed with the body 1a. In the body block 1, the body 1a and the cover 1b are each molded of synthetic resin. The body 1a and the cover 1b can be coupled together by using, e.g., screws. Furthermore, in the body block 1, a packing 1c, which has an annular shape in a plan view and is made of a flexible material such as synthetic rubber, is interposed between the body 1a and the cover 1b. This prevents the occurrence of a gap between the body 1a and the cover 1b, thereby ensuring its waterproof property.

Moreover, the body block 1 includes electronic components mounted on a printed-wiring board (not shown), the electronic components including the light indicators 1d, the power supply circuit 11, the control circuit 12, the relay 13, and the like. The body block 1 accommodates the printed-wiring board having the electronic components thereon within the accommodation recess 1aa.

Next, at one end of the first cable 2 of the power supply control device 10, there is provided a power plug 20 to be connected to the power source such as the external commercial AC power source. Plug pins 20a are protruded from an end of the power plug 20 (see FIG. 4). At the other end of the first cable 2, there is provided the attaching part 4 detachably connected to the body block 1. In the first cable 2, the power plug 20 and the attaching part 4 are electrically connected to each other via a cable part 2a. The attaching part 4 has the cylindrical inserting portion 4a.

The attaching part 4 can be made of an insulating resin material. As shown in FIG. 2, a plurality of insertion holes 4aa (three holes in FIG. 2) is provided in the end surface of the inserting portion 4a of the attaching part 4. Within the inserting portion 4a, conductive contacts 4e (see FIG. 1) serving as the connection terminals of the first cable 2 are provided corresponding to the respective insertion holes 4aa. In the first cable 2, each of the contacts 4e in the attaching part 4 is provided corresponding to the respective electric wires 2C1, 2C2, 2C3 in a one-to-one relationship.

In the inserting portion 4a, contact pieces 1e serving as the connection terminals of the body block 1 are respectively inserted into the contacts 4e through the insertion holes 4aa. Each of the contacts 4e is formed into a substantially C-shape in a cross-sectional view and contacts the contact piece 1e to hold it. The contact 4e has a pair of contact arms 4e1, 4e1 facing each other at the tip end of the contact 4e. In order to easily make the insertion of the contact piece 1e into between the contact arms 4e1, 4e1, the contact arms 4e1, 4e1 are bent outwardly away from each other. The contact 4e can be formed by punching and bending a metal plate. The contacts 4e of the first cable 2 come into contact with the respective contact piece 1e protruding in the cylindrical tubular portion 5a of the body block 1, and are electrically connected to the respective contact piece 1e (see FIG. 1).

In the power supply control device 10, the pair of contact arms 4e1, 4e1 of each of the contacts 4e is elastically deformed away from each other when the corresponding contact piece 1e is inserted into the contact 4e through the insertion hole 4aa by engaging the attaching part 4 in the attaching lock part 5. Each of the contacts 4e can hold the corresponding contact piece 1e using the contact pressure due to an elastic force generated by the elastic deformation of the contact arms 4e1, 4e1.

Further, the cylindrical tubular portion 5a of the attaching lock part 5 is formed to have an inner diameter slightly larger than an outer diameter of the inserting portion 4a so that the inserting portion 4a can be inserted into the cylindrical tubular portion 5a.

In the attaching lock part 5, the claws 6a of the elastic locking pieces 6 provided on an outer wall surface 5ab of the cylindrical tubular portion 5a are inserted through corresponding holes 5ac extending through from the outer wall surface 5ab to the inner wall surface 5aa to protrude into the cylindrical tubular portion 5a beyond the inner wall surface 5aa thereof. The attaching lock part 5 includes a deflection restricting part 9. The deflection restricting part 9 can slidably move between a locked position and an unlocked position. At the locked position, the deflection restricting part 9 restricts the deflection of the elastic locking pieces 6 so that the claws 6a remain engaged with the engaging portion 4ac. At the unlocked position, the deflection restricting part 9 allows the elastic locking pieces 6 to be deflected so that the protruding amount of the claws 6a into the cylindrical tubular portion 5a from the inner wall surface 5aa is decreased to release the engagement of the claws 6a with the engaging portion 4ac. In other words, the deflection restricting part 9 functions as a slide cover that slides along the outer wall surface 5ab of the cylindrical tubular portion 5a. The deflection restricting part 9 is biased by a coil spring 8 disposed on the outer wall surface 5ab of the cylindrical tubular portion 5a in the direction away from the body block 1. In the attaching lock part 5, by sliding the deflection restricting part 9 along the outer wall surface 5ab of the cylindrical tubular portion 5a in the insertion direction of the inserting part 4a (as indicated by the arrow in FIG. 7B), the elastic locking pieces 6 can be deflected in the direction away from the outer wall surface 5ab to release the engagement of the claws 6a with the engaging portion 4ac.

On the inner wall surface 5aa of the cylindrical tube 5a, there is provided a waterproof seal 7 brought into contact with the outer surface 4a1 of the inserting portion 4a to prevent water from infiltrating between the cylindrical tubular portion 5a and the inserting portion 4a. The waterproof seal 7 is formed of, e.g., an annular rubber member. By using the waterproof seal 7, the power supply control device 10 can prevent water from infiltrating between the cylindrical tubular portion 5a and the inserting portion 4a with a relatively simple structure. Further, the waterproof seal is provided closer to the contact pieces 1e than the holes 5ac in the insertion direction of the inserting portion 4a (see the arrow shown in FIG. 6B). Accordingly, in the power supply control device 10, the waterproof seal 7 can stop the water flowing into the cylindrical tubular portion 5a through the holes 5ac, into which the respective claws 6a of the elastic locking pieces 6 are inserted.

In the case where the inserting portion 4a of the attaching part 4 is inserted into the cylindrical tubular portion 5a of the attaching lock part 5, the contacts 4e are aligned to the respective contact pieces 1e and then the inserting portion 4a is inserted into the cylindrical tubular portion 5a.

Thus, the attaching lock part 5 includes an alignment portion 5ad in the cylindrical tubular portion 5a for aligning the contact pieces 1e with the contacts 4e. The contact pieces 1e and the contacts 4e serve as connection terminals that electrically connect the body block 1 to the first cable 2 when the inserting portion 4a is inserted into the cylindrical tubular portion 5a. The alignment portion 5ad may be an engaging protrusion with an elongated rectangular shape extending in the inserting direction of the inserting part 4a into the cylindrical tubular portion 5a, and may be provided on the inner wall surface 5aa of the cylindrical tubular portion 5a. Further, in the inserting portion 4a, an engaging recess 4ab as an engaging key groove may be provided on the outer surface 4a1 of the inserting portion 4a to correspond to the engaging protrusion serving as the alignment portion 5ad. Thus, the alignment portion 5ad also function to restrict the first cable 2 to rotate relative to the body block 1, that is, to restrict the cylindrical inserting portion 4a from rotating about the central axis of the cylindrical tubular portion 5a. Accordingly, in the power supply control device 10, the alignment portion 5ad is inserted into the engaging recess 4ab, thereby making it easier to electrically and mechanically connect the first cable 2 to the body block 1.

In the power supply control device 10, the attachment and detachment of the first cable 2 with respect to the body block 1 can be achieved by using the claws 6a and the engaging portion 4ac. In other words, in the power supply control device 10, the cylindrical tubular portion 5a of the attaching lock part 5 includes the elastic locking pieces 6 each having the claw 6a. Herein, the claws 6a are protruded through a plurality of holes 5ac (four in this embodiment) into the cylindrical tubular portion 5a beyond the inner wall surface 5aa thereof. The holes 5ac are circumferentially arranged on the cylindrical tubular portion 5a so as to surround the inserting portion 4a. A plurality of elastic locking pieces 6 (four in this embodiment) is provided on a substantially C-shaped base 6b at predetermined intervals (see FIG. 2). The claws 6a and the base 6b are integrally formed of a resin material to provide the elastic locking pieces 6. In the body block 1 of the power supply control device 10, the base 6b is mounted in a ring-shaped groove 5ah formed in the outer wall surface 5ab of the cylindrical tubular portion 5a. The base 6b is sandwiched by protruding portions 5af and projecting portions 5ag, which are provided on the outer wall surface 5ab of the cylindrical tubular portion 5a. The claws 6a of the elastic locking pieces 6 can be elastically deformed relative to the base 6b.

In the inserting portion 4a of the attaching part 4, the engaging portion 4ac protrudes outwardly from the inserting portion 4a. The protrusion amount of the engaging portion 4ac increases gradually and decreases gradually from a predetermined position as it goes in the insertion direction of the inserting part 4a. That is, the engaging portion 4ac has a substantially V-shaped cross-section. Further, the attaching part 4 includes an annular waterproof ring 4c for preventing water from infiltrating between the inserting portion 4a and the cylindrical tubular portion 5a of the attaching lock part 5. The waterproof ring 4c may be formed of a flexible material such as synthetic rubber. The attaching part 4 includes a flange portion 4d protruding from the outer surface 4a1 of the inserting portion 4a for restricting the waterproof ring 4c from being displaced due to the contact with the cylindrical tubular portion 5a.

When the attaching part 4 is attached to the attaching lock part 5, the claws 6a are elastically deformed along the shape of the engaging portion 4ac whose protrusion amount from the inserting portion 4a increases gradually as the inserting portion 4a of the attaching part 4 is inserted into the cylindrical tubular portion 5a of the attaching lock part 5. As the inserting portion 4a is further inserted into the cylindrical tubular portion 5a, each of the claws 6a returns to the original position along the shape of the engaging portion 4ac whose protrusion amount from the inserting part 4a decreases gradually. In other words, each of the elastic locking pieces 6 has a substantially V-shaped cross-section and can be deformed to narrow the space in the V-shape. The claws 6a are engaged with the engaging portion 4ac to lock the first cable 2 in the body block 1.

In the power supply control device 10 of the present embodiment, the first cable 2 can be adapted to suit different shapes of power receptacles dependent on different regions, thereby being detachably connected to the body block 1.

Next, in the power supply control device 10 of the present embodiment, a locking operation of the first cable 2 and the body block 1 will be described in detail with reference to FIGS. 6A to 6D.

When the inserting part 4a of the attaching portion 4 is inserted into the cylindrical tubular portion 5a of the attaching lock part 5, the first cable 2 and the body block 1 are electrically connected while being locked. In the body block 1, as the inserting portion 4a is inserted into the cylindrical tubular portion 5a, the claws 6a, which protrude beyond the internal wall surface 5aa of the cylindrical tubular portion 5a, come into contact with the outer surface 4a1 of the inserting portion 4a to be deformed toward the inner wall surface 5aa of the cylindrical tubular portion 5a (see FIG. 6A).

When the inserting portion 4a is further inserted into the cylindrical tubular portion 5a of the body block 1, the inserting portion 4a comes into contact with the annular waterproof seal 7. The waterproof seal 7 is provided closer to the contact pieces 1e than the holes 5ac in the inserting direction of the inserting portion 4a (see the arrow shown in FIG. 6B). The waterproof seal 7, which is provided on the inner wall surface 5aa of the cylindrical tubular portion 5a, prevents water from infiltrating between the cylindrical tubular portion 5a and the inserting portion 4a (see FIG. 6B).

Moreover, when the inserting portion 4a is inserted into the cylindrical tubular portion 5a of the body block 1, the alignment portion 5ad as the engaging protrusion is engaged with the engaging recess 4ab. Herein, the alignment portion 5ad is provided on the inner wall surface 5aa of the cylindrical tubular portion 5a, and the engaging recess 4ab is provided on the outer surface 4a1 of the inserting portion 4a. Accordingly, the contact parts 4e are aligned with the respective contact pieces 1e, thereby enabling the contact pieces 1e to be inserted into the respective insertion holes 4aa (see FIG. 6C).

Finally, when the inserting portion 4a is inserted into the cylindrical tubular portion 5a until the tip end thereof comes into contact a bottom surface 5ae of the cylindrical tubular portion 5a of the body block 1, the contact parts 4e are electrically and mechanically connected to the respective contact pieces 1e. Further, the claws 6a come into contact with the engaging portion 4ac of the inserting portion 4a, thereby preventing the inserting portion 4a from being disconnected from the cylindrical tubular portion 5a (see FIG. 6D).

When the inserting portion 4a is inserted into the cylindrical tubular portion 5a and the claws 6a climb over the engaging portion 4ac of the inserting portion 4a, the engaging portion 4ac is locked by the biasing force of the claws 6a.

Next, in the power supply control device 10 of the present embodiment, an unlocking operation of the first cable 2 and the body block 1 will be described in detail with reference to FIGS. 7A to 7C.

As shown in FIGS. 7A and 7B, in the case where the attaching part 4 is detached from the attaching lock part 5, the deflection restricting part 9 serving as the slide cover is moved toward the body block 1 of the power supply control device 10 against the biasing force of the coil spring 8 (as indicated by the arrow in FIG. 7B). In other words, the deflection restricting part 9 is moved from the locked position to the unlocked position. When the deflection restricting part 9 is slid, a part of each elastic locking piece 6 is accommodated in an accommodation recess 9a defined in the deflection restricting part 9. Thus, the part of each elastic locking piece 6 does not come into contact with the deflection restricting part 9 while the base 6b of each elastic locking piece 6 remains held in the attaching lock part 5.

In this state, the inserting portion 4a is moved in a direction of detachment from the cylindrical tubular portion 5a (see the arrow shown in FIG. 7C). Then, the engaging portion 4ac, which protrudes from the outer surface 4a1 of the inserting portion 4a, presses the claws 6a to come out of the respective holes 5ac, so that the elastic locking pieces 6 are elastically deformed away from the outer wall surface 5ab (see FIG. 7C).

Thus, in the power supply control device 10 of the present embodiment, the first cable 2 is unlocked from the body block 1 so that the first cable 2 can be detached from the body block 1.

Although, in the power supply control device 10 of the present embodiment, the first cable 2 is detachably connected to the body block 1, the second cable 3 instead of the first cable 2 may be detachably connected to the body block 1. Further, both of the first cable 2 and the second cable 3 may be detachably connected to the body block 1.

In any case, the power supply control device 10 of the present embodiment makes it easy to attach and detach the cable to and from the body block 1.

While the invention has been shown and described with respect to the embodiments, it will be understood by those skilled in the art that various changes and modification may be made without departing from the scope of the invention as defined in the following claims.

1. A power supply control device, comprising:
a body block including a power supply control unit for controlling power supply to an electric motor vehicle;
a first cable, connected to the body block, for receiving electric power from a power source; and
a second cable, connected to the body block, for feeding the electric power to the electric motor vehicle,
wherein one of the body block, and the first cable or the second cable includes an attaching lock part having a tubular portion; and the other of the body block, and the first cable or the second cable includes an attaching part having an inserting portion to be inserted into the tubular portion, and
wherein the attaching lock part includes an elastic locking piece having a claw whose protruding amount from an inner wall surface of the tubular portion is variable; and the claw is engaged with an engaging portion provided on an outer surface of the inserting portion to lock the attaching part.

2. The power supply control device as set forth in claim 1, wherein the attaching lock part includes an alignment portion, provided in the tubular portion, for aligning a connection terminal of the body block with a connection terminal of the first or second cable to be electrically connected to each other when the inserting portion is inserted into the tubular portion.

3. The power supply control device as set forth in claim 1, wherein the tubular portion includes a waterproof seal provided on the inner wall surface thereof, the waterproof seal being in contact with the outer surface of the inserting portion and preventing water from infiltrating between the tubular portion and the inserting portion.

4. The power supply control device as set forth in claim 2, wherein the tubular portion includes a waterproof seal provided on the inner wall surface thereof, the waterproof seal being in contact with the outer surface of the inserting portion and preventing water from infiltrating between the tubular portion and the inserting portion.

5. The power supply control device as set forth in claim 3, wherein the attaching lock part further comprises a deflection restricting part which is in contact with the elastic locking piece to restrict the elastic locking piece from being deflected in a direction away from the outer wall surface and keep the elastic locking piece in a state that the claw is engaged with the engaging portion;
wherein the claw of the elastic locking piece provided on the outer wall surface of the tubular portion is inserted through a hole to protrude into the tubular portion beyond the inner wall surface thereof, the hole extending through from the outer wall surface to the inner wall surface; and
wherein the deflection restricting part is slidable between a locked position where the deflection restricting part is in contact with the elastic locking piece to restrict the elastic locking piece from being deflected away from the outer wall surface and keep the elastic locking piece in the state that the claw is engaged with the engaging portion and an unlocked position where the elastic locking piece is allowed to be deflected so that the protruding amount of the claw from the inner wall surface into the tubular portion is decreased to release the engagement of the claw with the engaging portion.

6. The power supply control device as set forth in claim 4, wherein the attaching lock part further comprises a deflection restricting part which is in contact with the elastic locking piece to restrict the elastic locking piece from being deflected in a direction away from the outer wall surface and keep the elastic locking piece in a state that the claw is engaged with the engaging portion;
wherein the claw of the elastic locking piece provided on the outer wall surface of the tubular portion is inserted through a hole to protrude into the tubular portion beyond the inner wall surface thereof, the hole extending through from the outer wall surface to the inner wall surface; and wherein the deflection restricting part is slidable between a locked position where the deflection restricting part is in contact with the elastic locking piece to restrict the elastic locking piece from being deflected away from the outer wall surface and keep the elastic locking piece in the state that the claw is engaged with the engaging portion and an unlocked position where the elastic locking piece is allowed to be deflected so that the protruding amount of the claw from the inner wall surface into the tubular portion is decreased to release the engagement of the claw with the engaging portion.

7. The power supply control device as set forth in claim 6, wherein the waterproof seal is provided closer to the connection terminal of the body block than the hole in an inserting direction of the inserting portion.
